(19) United States
(12) Patent Application Publication
(10) Pub. No.: US 2004/0021000 A1
(43) Pub. Date: Feb. 5, 2004

(54) Flask for medicinal preparations

(76) Inventor: Vladimir Nikolaevich Denisov, Kazanskaya (RU)

Correspondence Address: McCormick Paulding & Huber, City Place II, 185 Asylum Street, Hartford, CT, 06103-3402, US

(21) Appl. No.: 10/297,808

(22) PCT Filed: Jun. 8, 2001
(86) PCT No.: PCT/RU01/00225

(30) Foreign Application Priority Data
Jun. 15, 2000 (RU) 200115026

(51) Int. Cl. A61L 9/04

(52) U.S. Cl. 239/44

(57) ABSTRACT

A flask for medicinal preparations comprises a reservoir (1) with an orifice in the form of a neck (2), a rod (3) tightly fitted in the neck (2) and having one end extending outside the reservoir, and a sealing cap (10) placed above the neck of the reservoir. The rod (3) is made of a fibrous material (5) formed by longitudinal fibers and arranged in a casing (6) having a length less than that of the fibrous material at least for the outer part of the rod so as to form a brush (7). The fibrous material is embodied in the form of a bunch of longitudinal threads of natural or synthetic fibers.

A portion of the casing of the rod inside the reservoir is provided with a perforation (8) or a spiral slot (9), and the sealing cap (10) is connected to a head part of the reservoir by means of a releasable connection.

### FIELD OF THE INVENTION

The invention relates to medical equipment, in particular, flasks for storing liquid medicinal preparations and application thereof to the skin, and further can be used for treating a wound surface either in a clinic or as personal means for first medical aid in case of cuts, bruises, etc.

### BACKGROUND ART

What is known is a liquid drug formulation flask embodied in the form of a reservoir made of a glass mass, having a threaded neck and a plastic cap screwable on the neck, and a plastic or polyethylene plug, which flask is specified by State Standard GOST 17768-90, p. 4.1, table 1, Standards Publishing House, 1990. Of all the liquid medicinal preparations produced by the domestic pharmaceutical industry, most is prepackaged in such the flasks. To apply a medicine to the wound surface, one shall unscrew the cap, pull the plug out of the neck, let the liquid from the flask soak in a cotton-wool tampon, and treat the skin with the tampon. Before the treatment, the flask shall preferably be plugged up so as to prevent an accident spilling of the medicinal preparation. The described procedure shall be repeated in whole if it is necessary to treat the surface again. It impairs consumer properties of the flask. Besides, the cotton or cotton-gauze tampon that shall be utilized after use is wetted with more medicinal preparation than the treatment of the wound surface requires, and the liquid from such the flask is being consumed inefficiently. Moreover, the cotton tampon cannot enable a person to remove microparticles, e.g. skin particles, dirt or mechanical impurities.

The background art includes devices for applying liquid, paste-like or powder-like substances to a surface. Such a device has a brush at one end, for example, the device described in U.S. Pat. No. 4,826,339, A46B11/00. 1989. This known device comprises a tubular casing for a material to be applied, a flexible brush fixed to a neck of the casing, a cylindrical sleeve and a cap for protecting the brush against damage or crinkle when the cap is being fitted in position to the tubular casing. In said device the material in the casing is squeezed to the brush through a guide tube forming a channel. To apply the material, the brush shall be pressed to the skin along with the rigid guide tube disposed in that brush, which may cause further injuring the wound surface if the device is used for applying a medicinal preparation. Then, a discharge of the material through a single central guide tube may not allow a uniform wetting of the brush, especially when in frequent use the tube becomes blocked up at one end with the material from the reservoir (casing), and the other end of the tube is clogged with particles being sucked up from outside when the squeezed casing is released. As the result, the effectiveness of using the device will inevitably be impaired.

The prior art closest to the claimed invention by technical gist represents a device for medicinal preparations described in USSR 1805980, A61M35/00, 1993, comprising a reservoir with a neck, a hard porous rod mounted to the reservoir in such a way that one of the ends thereof extends through the neck outside the reservoir, and a sealing cap placed above the neck. The reservoir contains a porous medium impregnated with a medical preparation solution. The reservoir and the porous material of the medium are elastic. The solution is prevented from flowing out of the flask by capillary forces inherent to said medium of highly porous material, such as cotton wool, silica gel, etc. The medicinal preparation can be applied to the skin with the porous rod arranged in the neck, the rod is made of, e.g. felt, felted cloth, gauze, etc. and is in contact with the medium impregnated with the solution. The flask ensures more economical application of medicinal preparations to the skin.

However, when treating the skin with such a flask it is practically impossible to regulate the dosing of a liquid preparation, as the porous rod cannot be wetted more intensively because of capillary forces of the porous medium. The discharge of the medicinal preparation to the treated surface becomes more difficult with the lapse of time and repeated use, and in some cases the preparation can be totally blocked due to capillary choking in the outer part of the rod. The choking results from crystallization of an unused part of the preparation that is unable to return to the flask. Besides, the porous filling material decreases the payload volume of a liquid in the flask. All that makes the device ineffective when a sufficiently large wound surface shall be treated, or the surface shall be wetted more intensively.

Then, the dense porous rod may not enable a person to remove microparticles from a wound, e.g. skin particles, dirt or mechanical impurities, without having the wound further injured, which limits the field of application of the device.

### SUMMARY OF THE INVENTION

The invention is directed to create a flask for medicinal preparations, convenient and efficient in service, having a wider field of application. In the inventive flask said objects are achieved by providing an unhampered discharge of a medicinal preparation to the surface under treatment, and by simultaneous cleaning the surface from microparticles.

To this end, it is proposed the flask for medicinal preparations, comprising a reservoir with an orifice in the form of a neck, a rod tightly fitted in the neck and having one end extending outside the reservoir, and a sealing cap placed above the neck of the reservoir. The rod is made of a fibrous material formed by longitudinal fibers and arranged in a casing so as to form a capillary network between the fibers. The casing has a length less than that of the fibrous material at least for the outer part of the rod. The rod is arranged in the reservoir to contact the medicinal preparation, and the fibrous material of the rod is embodied in the form of a bunch of longitudinal threads of natural or synthetic fibers inert to medicinal preparations.

A portion of the casing of the rod inside the reservoir is perforated or spirally slotted, and the sealing cap is connected to a head part of the reservoir by means of a releasable connection.

### BRIEF DESCRIPTION OF THE DRAWINGS

The invention is explained by accompanying drawings where

FIG. 1 schematically illustrates a sectional view of the inventive flask;

FIG. 2 illustrates a rod arranged in a perforated casing;

FIG. 3 illustrates the rod arranged in a spirally slotted casing;

FIG. 4 illustrates a cross sectional view of the rod taken along the lines A-A.

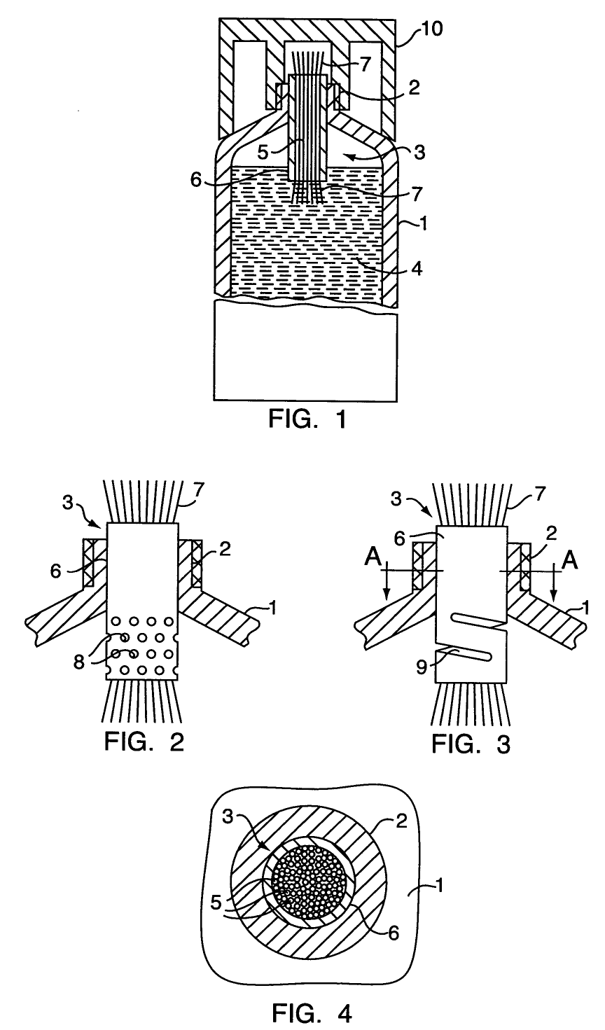

### BEST MODE FOR CARRYING OUT THE INVENTION

A flask for medicinal preparations comprises a reservoir 1 with a neck 2, in which neck, a rod 3 of a fibrous material is tightly fitted. The rod is in contact with a liquid medicinal preparation 4.

The rod 3 is made of the fibrous material 5 having longitudinal fibers arranged in an elastic casing 6 of rubber, polyvinyl or other polymeric material, for instance. A bunch of longitudinal threads of natural, e.g. cotton, silk, etc, or synthetic, e.g. capron, etc fibers inert to medicinal preparations can serve as the fibrous material 5. A capillary network is formed between the fibers, thereby allowing a discharge of the medicinal preparation 4.

A length of the casing 6 is chosen to be somewhat less than that of the fibrous material 5 so as to form a brush 7 on the outer part of the rod. The inner part of the rod 3 disposed in the reservoir 1 may as well terminate with a brush 7 of the fibrous material 5 protruding outside the casing 6. When in the beginning of using the flask, the reservoir 1 is filled with the medicinal preparation 4, the lower brush 7 is fully immersed in the preparation.

The rod 3 is fitted in the neck 2 at a stretch. The rod 3 is thereby fixed in the neck of the reservoir 1, and is prevented from being pushed out when extra hydraulic pressure is applied thereto as a result of turning the flask upside-down into the operating position.

A length of the rod 3 is chosen to ensure its repeated use with periodical cutting its outer end contacting the treated surface. At the same time, as a result of shortening the part of the rod 3 inside the reservoir 1 the impact of hydrostatic pressure of the medicinal preparation is transferred directly to the section of the rod, and the path of the solution through capillaries is also shortened.

In order to improve the wetting of the fibrous material 5 with the liquid medicinal preparation 4, especially when the material is running short, and to ensure the effect of capillary forces, a portion of the casing 6 of the part of the rod 3 inside the reservoir is provided with a perforation 8 or a spiral slot 9.

A sealing cap 10 is placed above the neck 2 of the reservoir by means of a releasable connection, e.g. a threaded connection. The cap is embodied in the form of a cover hermetically closing the neck 2. The threaded connection between the reservoir 1 and the sealing cap 10 improves the sealing of the device.

The reservoir 1 can be made of any material that is inert to medicinal preparations, e.g. glass, plastic, ceramic, etc.

It should be noted that embodiments of different components of the flask, for example, the reservoir, the neck, the rod casing or the cap, and materials for manufacturing thereof, are not limited by those given in the description and the accompanying drawings. It is understandable that the components can be realized in other forms falling within the scope of the invention, and the description encompasses the best mode for carrying out the invention.

The flask shall be utilized as follows. Being in hand, the flask is turned with the cap 10 downward to ensure a proper wetting and impregnation of the rod 3 with the medicinal preparation 4. The other reason for turning the flask upside-down is to prevent spilling a liquid, which could flow out spontaneously in the course of transportation, on hands or surrounding objects. Then the sealing cap 10 is detached (unscrewed) from a head piece of the reservoir 1, and the preparation is applied to the wound surface by making contact between the brush 7 of the rod 3 and the skin. At the same time, separate fibers of the brush enter surface irregularities and lubricate them with the medicine. The irregularities are further cleaned by said fibers from skin microparticles and mechanical impurities (dust, small chips, etc) that got therein, without further injuring the wound surface. By pressing the outer brush 7 to the treated surface, it is possible to apply the preparation with a full brush, thereby increasing the treatment intensity and speed.

When in the beginning of using the flask with the medicinal preparation, the rod 3 and the inner brush 7 is fully immersed in the liquid that wets the rod under the effect of capillary forces. As the liquid is being consumed for treating the surface, an increasing tilt of the flask is required, up to the complete overturn, and the fibrous material 5 is wetted via the perforation 8 or the spiral slot 9.

In the case where the medicinal preparation, apart from medical properties, has some antiseptic effect, and as the outer brush 7 is worn out by abrasion, the rod 3 may be pulled out of the flask and forced in the neck turning the inner brush out. Once the surface has been treated, the cap shall be screwed on the head piece of the reservoir again.

Industrial Applicability

The use of the inventive flask may allow an economical and efficient treatment of a wound surface with medicinal preparations, and simultaneous cleaning the surface from microparticles.

In addition, the invention may allow a several times increase of a volume of the medicinal preparation in the flask, as compared to the closest prior art. With a transparent reservoir of the flask, the medicinal preparation contained therein can be visually controlled. Besides, the flask according to the present invention can be more conveniently used in traveling, household and field conditions.

1. Flask for medicinal preparations, comprising a reservoir with an orifice in the form of a neck, a rod tightly fitted in the neck and having one end extending outside the reservoir, and a sealing cap placed above the neck of the reservoir, characterized in that the rod is made of a fibrous material with longitudinal disposed fibers and arranged in a casing so as to form a capillary network between the fibers, wherein the casing has a length less than that of the fibrous material at least for the outer part of the rod.

2. Flask according to claim 1 characterized in that the fibrous material is embodied in the form of a bunch of longitudinal threads of natural or synthetic fibers inert to medicinal preparations.

3. Flask according to claim 1 characterized in that the casing of the rod is elastic.

4. Flask according to claim 1 characterized in that the rod is adapted to contact the medicinal preparation.

5. Flask according to any of claims 1 to 4 characterized in that a portion of the casing of the rod inside the reservoir is perforated.

6. Flask according to any of claims 1 to 4 characterized in that a portion of the casing of the rod inside the reservoir is spirally slotted.

7. Flask according to any of claims 1 to 6 characterized in that the sealing cap is connected to a head piece of the reservoir by means of a releasable connection.
